(19) United States
(12) Patent Application Publication
(10) Pub. No.: US 2009/0007576 A1
(43) Pub. Date: Jan. 8, 2009

(54) Methods and Systems for a Torque-Based Air Conditioning Cut-Out Control

(76) Inventor: Frederic J. Boissinot, Ann Arbor, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 11/773,788

(22) Filed: Jul. 5, 2007

(51) Int. Cl. F25D 29/00; B60H 1/32

(52) U.S. Cl. 62/161; 62/244; 62/133

(57) ABSTRACT

The present disclosure adjusts an air conditioner (A/C) compressor load responsive to the available torque to provide a compromise between A/C system and vehicle performance. The maximum available torque is monitored in real-time, and it is determined if there is enough torque to keep the A/C on for a fixed displacement compressor or how much the compressor displacement can be destroked through a current control for a variable displacement compressor. In an exemplary embodiment, an engine control unit (ECU) broadcasts the maximum available torque at a flywheel based on sensor readings and calculations. Accordingly, this broadcast enables a determination of whether there is enough torque available to maintain the A/C system in a controlled manner. Advantageously, the present disclosure avoids an abrupt turn-off or turn-on of the A/C system. Rather, the present disclosure maintains the A/C system in a controlled manner providing improved vehicle driveability.

### FIELD OF THE DISCLOSURE

The present disclosure relates generally to an air conditioning (A/C) system associated with an Internal Combustion Engine (ICE) of a vehicle. More specifically, the present disclosure provides methods and systems for a torque-based air conditioning (A/C) cut-out control, providing an algorithm that determines, when a driver requests maximum performance from a vehicle, the maximum flywheel torque available before shutting off the A/C in a fixed displacement A/C system or destroking the compressor in a variable displacement A/C system.

### BACKGROUND OF THE DISCLOSURE

A compressor in an A/C system associated with an Internal Combustion Engine (ICE) of a vehicle is used to both move mid pressurize a refrigerant. The compressor is typically connected to a rotating crankshaft along with the ICE; therefore the compressor is a load on the engine, i.e., the compressor utilizes output torque. Compressors generally are one of fixed displacement (FDAC) where the compressor is configured to pump a fixed capacity and variable displacement (VDAC) where the compressor includes internal valves that allow a variable pumping capacity. Conventionally, to provide better vehicle performance, the A/C system is typically shut off for a certain period of time when a driver is requesting acceleration or maximum torque. This reduces the A/C system's load on the engine, adding to the engine output the torque that was consumed when the A/C system was on. Disadvantageously, this is a crude algorithm and it fails to assess the maximum torque available that the engine could provide.

### BRIEF SUMMARY OF THE DISCLOSURE

In various exemplary embodiments, the present disclosure adjusts an A/C compressor load responsive to the available torque to provide a compromise between A/C and vehicle performance. The present disclosure monitors the maximum available torque, and then determines if there is enough torque to keep the A/C on for a fixed displacement compressor or how much the compressor displacement can be destroked through a current control for a variable displacement compressor. In an exemplary embodiment, an engine control unit (ECU) broadcasts the maximum available torque at a flywheel. Accordingly, this broadcast enables a determination of whether there is enough torque available to maintain the A/C system in a controlled manner. Advantageously, the present disclosure avoids an abrupt turn-off or turn-on of the A/C system. Rather, the present disclosure maintains the A/C system in a controlled manner providing improved vehicle driveability.

Advantageously, the torque-based A/C cut-out control method and system of the present invention overcomes many of the deficiencies known in the art pertaining to A/C control systems. The present invention provides an adjustable A/C compressor load relative to available torque. The present invention additionally provides an efficient balance between A/C performance and engine performance. Furthermore, the present invention further provides a method and system in which no abrupt shut-off or turn-on of the A/C system is required to increase engine performance, thereby providing better drivability in a controlled manner.

In an exemplary embodiment of the present disclosure, a torque-based air conditioning cut-out control method for a compressor on an air conditioner associated with an Internal Combustion Engine of a vehicle includes monitoring maximum available torque at a flywheel, monitoring required torque from an engine, comparing maximum available torque to required torque, and performing air conditioning cut-out control responsive to the comparing step. In one embodiment, the performing air conditioning cut-out control step includes turning off a fixed displacement compressor. In another embodiment, the performing air conditioning cut-out control step includes destroking a variable displacement compressor. The monitoring maximum available torque step includes one of measuring air going into the engine; performing a calculation based on a manifold absolute pressure sensor reading, mass air flow sensor reading, and engine revolutions per minute reading; measuring a spark applied and fuel delivered to the engine; measuring air and fuel delivered to the engine; measuring ambient pressure and air charge temperature; and combinations thereof. The monitoring required torque step comprises performing a calculation based upon a pedal position sensor compared to one of vehicle speed, engine speed, and combinations thereof. The performing air conditioning cut-out control step is performed only if the maximum available torque cannot support the required torque and an air conditioning system.

In another exemplary embodiment of the present disclosure, a torque-based air conditioning cut out control system for a vehicle includes a plurality of sensors disposed throughout the vehicle, as output connected to a compressor of an air conditioning system, wherein the output includes one of a relay and a pulse width modulation driver, and an electronic control unit in communication with each of the plurality of sensors and the output. The electronic control unit is configured to calculate and compare maximum available torque and current required torque responsive to inputs from the plurality of sensors, and control the air conditioning system through the output responsive to the comparison between maximum available torque and current required torque. In one embodiment, the compressor includes a fixed displacement compressor, and the control step includes turning off the fixed displacement compressor if the maximum available torque cannot support the current required torque and the air conditioning system. In another embodiment, the compressor includes a variable displacement compressor, and the control step includes destroking the variable displacement compressor if the maximum available torque cannot support the current required torque and the air conditioning system. The plurality of sensors include one of a manifold absolute pressure sensor, a mass air flow sensor, a throttle position sensor, an air temperature sensor, an oxygen sensor, a pedal position sensor, an air charge temperature sensor, a coolant temperature sensor, a crank sensor, a camshaft sensor, and combinations thereof. The maximum available torque includes a calculation based on measured air going into the engine; manifold absolute pressure, mass air flow, and engine revolutions per minute; a spark applied and fuel delivered to the engine; air and fuel delivered to the engine; ambient pressure and air charge temperature; and combinations thereof. The current required torque includes a calculation based upon a pedal position sensor compared to one of vehicle speed, engine speed, and combinations thereof.

In yet another embodiment of the present disclosure, an air conditioner system for a vehicle includes a compressor connected to a crankshaft of the vehicle, an output connected to the compressor, wherein the output includes one of a relay and a pulse width modulation drive. The output is configured to drive the compressor responsive to currently available torque. In one embodiment, the compressor includes a fixed displacement compressor, and the output is turned off if a maximum available torque cannot support current required torque and the air conditioning system. In another embodiment, the compressor includes a variable displacement compressor, and current is adjusted on the output to destroke the variable displacement compressor if a maximum available torque cannot support current required torque and the air conditioning system.

### BRIEF DESCRIPTION OF THE DRAWINGS

The present disclosure is illustrated and described herein with reference to the various drawings, in which like reference numbers denote like system components, respectively, and in which:

FIG. 1 is a flowchart illustrating an exemplary embodiment of the present disclosure for controlling A/C cut-out responsive to available torque;

FIG. 2 is a flowchart illustrating an A/C control algorithm according to an exemplary embodiment of the present disclosure; and

FIG. 3 is a block diagram illustrating an Engine Control Unit (ECU) configured to operate the A/C control algorithm, according to an exemplary embodiment of the present disclosure.

### DETAILED DESCRIPTION OF THE DISCLOSURE

In various exemplary embodiments, the present disclosure adjusts an A/C compressor load responsive to the available torque to provide a compromise between A/C and vehicle performance. The present disclosure monitors the maximum available torque, and then determines if there is enough torque to keep the A/C on for a fixed displacement compressor or how much the compressor displacement can be destroked through a current control for a variable displacement compressor. In an exemplary embodiment, an engine control unit (ECU) broadcasts the maximum available torque at a flywheel. Accordingly, this broadcast enables a determination of whether there is enough torque available to maintain the A/C system in a controlled manner. Advantageously, the present disclosure avoids an abrupt turn-off or turn-on of the A/C system. Rather, the present disclosure maintains the A/C system in a controlled manner providing improved vehicle driveability.

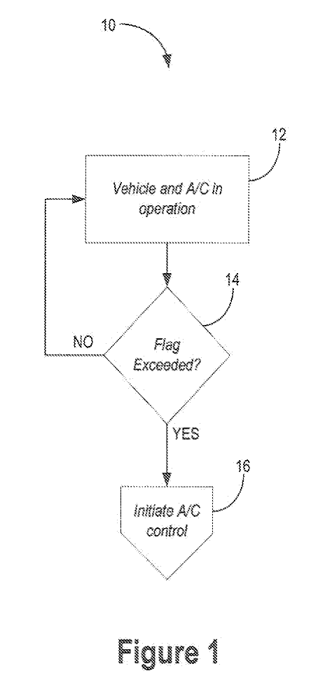

Referring to FIG. 1, a flowchart 10 illustrates an exemplary embodiment of the present disclosure for controlling A/C cut-out responsive to available torque. First, a vehicle is in operation, and the vehicle's A/C is on (step 12). As described herein, the A/C system consumes torque through the A/C system's compressor. A Wide Open Throttle (WOT) flag or Maximum Torque Request from Driver flag is checked (step 14). The WOT or maximum torque flag determines if the vehicle requires maximum power from the engine. In an exemplary embodiment, the torque flag is defined by comparing pedal position to a calibratable threshold. The pedal position can be determined by a pedal position sensor. In another exemplary embodiment, the torque flag can be defined by current vehicle and/or engine speed compared to a calibratable threshold. A determination that the flag is exceeded means the vehicle requires launch performance, wide-open throttle (WOT), or maximum performance request (i.e., in order to cover a diesel engine where there is no throttle mode). For example, the flag could include close to wide-open throttle (WOT), pedal position at the floor, and the like. If the flag is not exceeded, the flowchart 10 returns to step 12. If the flag is exceeded, then an A/C control algorithm is initiated (step 16). For example, the flowchart 10 can operate as a continuous loop checking to see when maximum power is requested, and once requested, the flowchart 10 enters into an AC control algorithm.

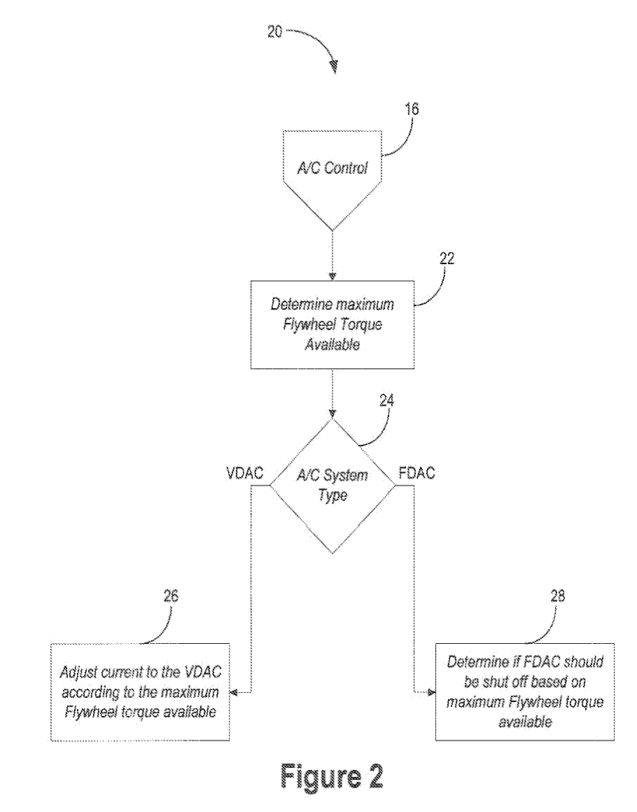

Referring to FIG. 2, a flowchart 20 illustrates an A/C control algorithm according to an exemplary embodiment of the present disclosure. As described in FIG. 1, the A/C control algorithm is started responsive to a determination that the vehicle requires launch performance, WOT, or maximum performance request (step 16). The maximum flywheel torque available is determined (step 22). A real-time measurement of torque available at the flywheel is provided, and can be calculated through various methods as are known in the art. For example, the calculation can be through the air going into the engine, such as measured by manifold absolute pressure (MAP) or Mass Air Flow (MAP) sensors reading and engine revolutions per minute (RPM), spark applied and fuel delivered for a gasoline engine, air and fuel delivered for a diesel engine, and air charge temperature and ambient pressure. With the real-time measurement of torque provided, the maximum available torque can be assessed based upon a calibratable threshold as to whether there is enough torque to maintain the operation of the A/C system or whether cut measures should be taken.

A/C cut measures depend on the A/C system type (step 24). For a variable displacement compressor (VDAC), current provided to the VDAC is adjusted according to the maximum flywheel torque available (step 26). For a fixed displacement compressor (FDAC), it is determined if the FDAC should be shut off based on the maximum flywheel torque available (step 28). Advantageously, monitoring and determining the maximum available torque in real-time allows for A/C system control in a controlled manner balancing A/C system performance with vehicle performance. For an FDAC, if it is determined that there is enough torque, the present disclosure maintains the A/C system in operation. For a VDAC, it is determined how much the compressor displacement should be destroked through a current control responsive to the maximum available torque. This prevents an abrupt, arbitrary shut off or turn-on of the A/C system.

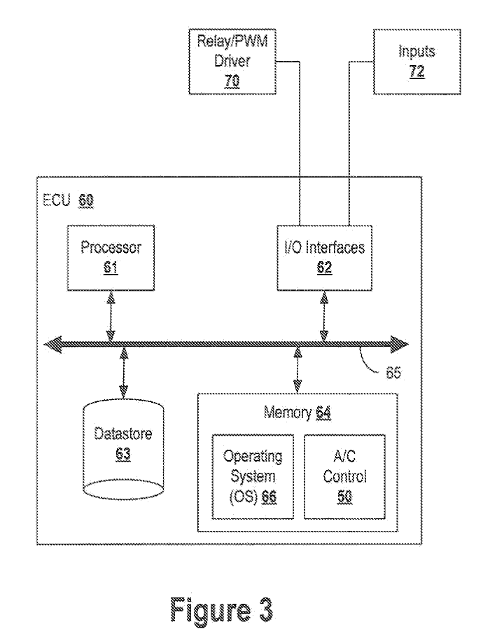

Referring to FIG. 3, a block diagram illustrates an ECU 60 configured to operate an A/C control algorithm 50, according to an exemplary embodiment of the present disclosure. The ECU, also known as an Engine Control Module (ECM) or Powertrain Control Unit/Module (PCU, PCM) if it controls both an engine and a transmission, is an electronic control unit which controls various aspects of an Internal combustion engine's operation. For example, ECUs control the quantity of fuel injected into each cylinder each engine cycle, the ignition timing, Variable Valve Timing (VVT), the level of boost maintained by the turbocharger (in turbocharged cars), and control other peripherals. ECUs determine the quantity of fuel, ignition timing and other parameters by monitoring the engine through sensors. These can include a MAP sensor, a mass air flow (MAF) sensor, throttle position sensor, air temperature sensor, oxygen sensor, pedal position sensor, air charge temperature sensor, coolant temperature sensor, crank sensor, camshaft, sensor, and the like.

The ECU 60 can be a digital computer that, in terms of hardware architecture, generally includes a processor 61, input/output (I/O) interfaces 62, a data store 63, and memory 64. The components (61, 62, 63, and 64) are communicatively coupled via a local interface 65. The local interface 65 can be, for example, one or more buses or other wired or wireless connections, as is known in the art. The local interface 65 can have additional elements, which are omitted for simplicity, such as controllers, buffers (caches), drivers, repeaters, and receivers, among many others, to enable communications. Further, the local interface 65 can include address, control, and/or data connections to enable appropriate communications among the aforementioned components.

The processor 61 is a hardware device for executing software instructions. The processor 61 can be any custom made or commercially available processor, a central processing unit (CPU), an auxiliary processor among several processors associated with the ECU 60, a semiconductor-based microprocessor (in the form of a microchip or chip set), or generally any device for executing software instructions. When the ECU 60 is in operation, the processor 61 is configured to execute software stored within the memory 64, to communicate data to and from the memory 64, and to generally control operations of the ECU 60 pursuant to the software instructions.

The I/O interfaces 62 are used to receive input from and/or for providing system output to one or more devices or components. I/O interfaces 62 can include, for example, a serial port, a parallel port, a small computer system interface (SCSI), a Controller Area Network bus (CANbus), a universal serial bus (USB) interface, and any other connection type as is known in the art. The I/O interfaces 62 are communicatively coupled to the processor 61, data store 63, and memory 64 through the local interface 65 providing communication to/from the ECU 60 and various components and sensors in the vehicle.

In an exemplary embodiment of the present disclosure, the I/O interfaces are connected to a relay/Pulse-width modulation (PWM) driver 70 and a plurality of inputs 72. In one exemplary embodiment, the relay/PWM driver 70 can be a relay to drive a FDAC providing a signal from the ECU 60 to turn the FDAC on and off. In another exemplary embodiment, the relay/PWM driver 70 can be a PWM driver for a VDAC providing a signal to control the current to the VDAC. The plurality of inputs 72 can include readings from various sensors throughout the vehicle. For example, the inputs 72 can include A/C head pressure, RPM, pedal position, MAP or MAP sensor readings, air charge temperature, coolant temperature, drivers for coils, and the like.

The data store 63 can be used to store information received from the I/O interfaces 62. The data store can include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the data store may incorporate electronic, magnetic, optical, and/or other types of storage media.

The memory 64 can include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 64 may incorporate electronic, magnetic, optical, and/or other types of storage media. Note that the memory 64 can have a distributed architecture, where various components are situated remotely from one another, but can be accessed by the processor 61.

The software in memory 64 can include one or more software programs, each of which includes an ordered listing of executable instructions for implementing logical functions. In the example of FIG. 3, the software in the memory system 64 includes the A/C control algorithm 50 and a suitable operating system (O/S) 66. Additionally, the AC control algorithm 50, O/S 66, or a stand-alone program can include a torque calculation algorithm configured to measure real-time torque based on readings from the inputs 72. The operating system 66 essentially controls the execution of other computer programs, such as the closed control loop 50 and other functions related to various aspects of an engine's operation, and provides scheduling, input-output control to/from the I/O interfaces and the relay/PWM driver 70 and inputs 72, file and data management, memory management, and communication control and related services.

In an exemplary embodiment of the present disclosure, the ECU 60 is configured to operate the A/C control algorithm 50 by receiving the plurality of inputs 72 through the I/O interfaces 62, monitoring maximum available torque versus required torque, and communicating appropriate actions to the relay/PWM driver 70 responsive the available torque. The ECU 60 is configured to maintain a real-time measurement of the maximum available torque at the flywheel. As described herein, this can be done by receiving the inputs 72, and performing calculations based on measurements from the MAP sensor reading and engine RPM, spark applied and fuel delivered for a gasoline engine, and air and fuel delivered for a diesel engine. The present disclosure contemplates any calculation of currently available maximum torque at the flywheel as is known in the art based on readings from various engine sensors.

The ECU 60 monitors in real-time the current required torque from both the A/C system and the engine. This monitoring allows the ECU 60 to adjust the A/C system through the relay/PWM driver 70 in a controlled manner providing a balance between A/C system and vehicle performance as opposed to a simple cut-off of the A/C system. Based on the monitoring, the ECU 60 calculates whether or not the A/C system must be turned off for a FDAC system or whether the A/C system must be destroked for a VDAC system. Advantageously, the A/C system control will only be adjusted when required based on the available torque. Additionally, the present disclosure can operate on an existing ECU 600 in vehicles with the addition of software code to operate the A/C control algorithm 50.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure and are intended to be covered by the following claims.

What is claimed is:

1. A torque-based air conditioning cut-out control method for a compressor on an air conditioner associated with an Internal Combustion Engine of a vehicle, comprising:
monitoring maximum available torque at a flywheel;
monitoring required torque from an engine;
comparing maximum available torque to required torque; and
performing air conditioning cut-out control responsive to the comparing step.

2. The torque-based air conditioning cut-out control method of claim 1, wherein the performing air conditioning cut-out control comprises turning off a fixed displacement compressor.

3. The torque-based air conditioning cut-out control method of claim 1, wherein the performing air conditioning cut-out control comprises destroking a variable displacement compressor.

4. The torque-based air conditioning cut-out control method of claim 1, wherein the monitoring maximum available torque step comprises one of:
measuring air going into the engine;
performing a calculation based on a manifold absolute pressure sensor reading, mass air flow sensor reading, and engine revolutions per minute reading;
measuring a spark applied and fuel delivered to the engine;
measuring air and fuel delivered to the engine;
measuring ambient pressure and air charge temperature; and
combinations thereof.

5. The torque-based air conditioning cut-out control method of claim 1, wherein the monitoring required torque step comprises performing a calculation based upon a pedal position sensor compared to one of vehicle speed, engine speed, and combinations thereof.

6. The torque-based air conditioning cut-out control method of claim 1, wherein the performing air conditioning cut-out control is performed only if the maximum available torque cannot support the required torque and an air conditioning system.

7. A torque-based air conditioning cut out control system for a vehicle, comprising:
a plurality of sensors disposed throughout the vehicle;
an output connected to a compressor of an air conditioning system, wherein the output comprises one of a relay and a pulse width modulation driver; and
an electronic control unit in communication with each of the plurality of sensors and the output, wherein the electronic control unit is configured to:
calculate and compare maximum available torque and current required torque responsive to inputs from the plurality of sensors; and
control the air conditioning system through the output responsive to the comparison between maximum available torque and current required torque.

8. The torque-based air conditioning cut out control system of claim 7, wherein the compressor comprises a fixed displacement compressor, and
wherein the control step comprises turning off the fixed displacement compressor if the maximum available torque cannot support the current required torque and the air conditioning system.

9. The torque-based air conditioning cut out control system of claim 7, wherein the compressor comprises a variable displacement compressor, and
wherein the control step comprises destroking the variable displacement compressor if the maximum available torque cannot support the current required torque and the air conditioning system.

10. The torque-based air conditioning cut out control system of claim 7, wherein the plurality of sensors comprise one of a manifold absolute pressure sensor, a mass air flow sensor, a throttle position sensor, an air temperature sensor, an oxygen sensor, a pedal position sensor, an air charge temperature sensor, a coolant temperature sensor, a crank sensor, a camshaft sensor, and combinations thereof.

11. The torque-based air conditioning cut out control system of claim 10, wherein the maximum available torque comprises a calculation based on:
measured air going into the engine;
manifold absolute pressure, mass air flow, and engine revolutions per minute;
a spark applied and fuel delivered to the engine;
air and fuel delivered to the engine;
ambient pressure and air charge temperature; and
combinations thereof.

12. The torque-based air conditioning cut out control system of claim 10, wherein the current required torque comprises a calculation based upon a pedal position sensor compared to one of vehicle speed, engine speed, and combinations thereof.

13. An air conditioner system for a vehicle, comprising:
a compressor connected to a crankshaft of the vehicle;
an output connected to the compressor, wherein the output comprises one of a relay and a pulse width modulation drive, and wherein the output is configured to drive the compressor responsive to currently available torque.

14. The air conditioner system for a vehicle of claim 13, wherein the compressor comprises a fixed displacement compressor, and
wherein the output is turned off if a maximum available torque cannot support current required torque and the air conditioning system.

15. The air conditioner system for a vehicle of claim 13, wherein the compressor comprises a variable displacement compressor, and
wherein current is adjusted on the output to destroke the variable displacement compressor if a maximum available torque cannot support current required torque and the air conditioning system.
